(19) United States
(12) Patent Application Publication
(10) Pub. No.: US 2012/0319586 A1
(43) Pub. Date: Dec. 20, 2012

(54) LED LAMP WITH INTEGRATED LIGHT DETECTOR

(76) Inventor: Scott Riesebosch, St. Catharines (CA)

(21) Appl. No.: 13/160,102

(22) Filed: Jun. 14, 2011

(51) Int. Cl. H05B 37/02

(52) U.S. Cl. 315/121

(57) ABSTRACT

Operation of an LED as a light source may be temporarily interrupted to facilitate measurement of the ambient light level, as well as control of the operation of the LED(s) based thereon.

### TECHNICAL FIELD

This invention relates to light detectors, and systems and methods for using the same to control the operation of light emitting diode (LED) lights.

### BACKGROUND

Street lamps are generally designed to automatically turn on at dusk and turn back off at dawn. While this functionality can be achieved by switching the lamps on or off at pre-determined times within a 24-hour cycle, modern street lamps typically operate based on measurements of the ambient light level. This approach eliminates the need to adjust the switching times during the year to reflect the varying times of sunrise and sunset, and further allows the lamps to automatically turn on during the day when the ambient light level is low, e.g., due to overclouding.

In most conventional street lamps, the photosensor for measuring the ambient light is shielded and/or positioned such that it does not receive a significant amount of light from the artificial light source of the lamp itself. For example, in some lamps, the ambient light sensor is separately mounted on top of a lampshade surrounding the downward-oriented light source. Such shielding and/or positioning facilitates accurate determination of the ambient light level, but adds complexity and cost to the lamp assembly. Therefore, alternative ways to measure the ambient light are needed. In particular, it would be desirable to enable integrating the photosensor with the light source without sacrificing sensor function and accuracy. In addition, it would be desirable for the photosensor to have the ability to measure not only the ambient light level, but also the light from the LEDs in the lamp assembly for, e.g., diagnostic purposes, and/or to receive modulated data communications.

### SUMMARY

The present invention generally provides systems and methods for controlling lamps intended to be controlled based on the ambient light level (such as, e.g., street lights and night lights) without the need to separate or shield the ambient light detector from the lamp, systems and methods for performing diagnostics on the light emitters producing the lamp's light, as well as systems and methods for enabling optical data communication with such lamps. In various embodiments, this is accomplished with LED lamps in combination with one or more sensors for detection of the ambient light, light from one or more of the LEDs in the lamp, and or light from other LEDs or optical sources in the lamp's vicinity. Electronic control circuitry that momentarily interrupts the LED operation as a light source may be utilized to facilitate unperturbed measurement of the light. The interruption is typically limited to time scales undetectable by the human eye. Such time scales can be achieved with LEDs, but generally not with incandescent light bulbs or fluorescent tubes. In various embodiments, therefore, the invention exploits the fast switching times of LEDs in order to measure ambient light, without shielding, during times at which the LEDs appear to be (but are, in fact, not) turned on. This approach allows placing the light detector in proximity to the light source (e.g., the LED) and/or integrating the light detector and the LED into a single chip.

In certain embodiments, one or more of the LEDs themselves is utilized as a light sensor when its operation as a light source is interrupted. During normal light-emission operation, each LED is forward biased; however, the properties and electronic structure of the LED may be advantageously harnessed to enable light detection when the LED operated under reverse bias. In such a mode, the LED detects light, e.g., from the ambient and/or from one or more of any other LEDs in the lamp, rather than emitting it.

In one aspect, embodiments of the invention provide a method for controlling operation of an LED assembly that includes at least one LED. The method involves operating the LED assembly as a light source; temporarily interrupting operation of the LED assembly as a light source and, during the temporary interruption, measuring an ambient light level; and adjusting the light intensity of the LED assembly based on the measured ambient light level.

Embodiments of the invention may include one or more of the following, in any of a variety of combinations. Adjusting the light intensity of the LED assembly may include or consist essentially of decreasing the light intensity when the ambient light level exceeds a threshold. Decreasing the light intensity of the LED assembly may include or consist essentially of discontinuing operation of the LED assembly as a light source. “Discontinuing operation of the LED assembly as a light source,” as the phrase is used herein, means that the LED assembly is turned off for a lengthy or indefinite time (typically, until the ambient light level falls below the specified threshold), as opposed to temporarily (i.e., for only a short time period intended for measurement of the ambient light). In some embodiments, the temporary interruption is not detectable by eye, and/or the duration of the temporary interruption does not exceed 5 ms, or even 1 ms.

To measure the ambient light level, one or more LEDs of the LED assembly may be used as a light sensor. Alternatively, the ambient light level may be measured with a light sensor optically proximate the LED assembly. In some embodiments, the measurement step is repeated periodically, and in some embodiments, it is repeated at specified time intervals (e.g., in the range from about 1 second to about 30 minutes), which may decrease toward dawn and/or as the ambient light level increases toward the threshold. Measuring the ambient light level may include measuring a temperature (e.g., of one or more of the LEDs or of the surrounding ambient) and determining the ambient light level based on the voltage at the LED used as the light sensor and the measured temperature.

The method may further include measuring the ambient light level while the LED assembly is not operated as a light source (e.g., at time intervals that decrease toward dusk and/or as the ambient light level decreases toward the threshold), and resuming operation of the LED assembly as a light source when the ambient light level falls below the specified threshold value. The cycle of operating the LED assembly as a light source, measuring (e.g., repeatedly) the ambient light level, discontinuing operation of the LED when the ambient light exceeds a set threshold, again measuring (e.g., repeatedly) the ambient light level, and resuming operation of the LED as a light source when the ambient light falls below the threshold may be repeated one or more times.

In some embodiments, the light level is also measured during the operation of the LED assembly as a light source. The operation of the LED assembly may then be adjusted based on the measured light level, e.g., by adjusting the duration of the temporary interruption and periodically repeating the temporary interruption so as to adjust an effective brightness of the LED assembly or by periodically repeating the temporary interruption and adjusting the brightness of the LED assembly by adjusting its drive current based at least in part on the ambient light levels measured during the temporary interruptions. For example, the intensity of light emitted by the LED assembly may be iteratively adjusted to (i) gradually decrease as the ambient light levels increase, and/or (ii) gradually increase as the ambient light levels decrease. In certain embodiments, the LED assembly includes a plurality of LEDs, and the light level is measured by temporarily operating one or more of the LEDs as a light sensor. For example, each of the LEDs may be operated as a light sensor individually and sequentially, in a round-robin fashion.

In another aspect, embodiments of the invention are directed to a lighting system that enables the method described above. The system includes an LED assembly operable as a light source (and having at least one LED), and control circuitry for (i) momentarily interrupting operation of the LED assembly as a light source and measuring, during the temporary interruption, an ambient light, and (ii) adjusting operation of the LED as a light source based on the measured ambient light level. The control circuitry may discontinue operation of the LED assembly as a light source when the measured ambient light level exceeds a threshold. The system may further include a light sensor (e.g., a photodiode, a phototransistor, a photoresistor, a radiometer, a photometer, a colorimeter, a spectral radiometer, or a camera), located in optical proximity to the LED assembly, for measuring the ambient light. The term “optical proximity,” as used herein, means that the sensor is exposed to substantial levels of light from the LED if the latter is turned on, i.e., there is substantially no shielding and, typically, a direct optical path between the two components. In some embodiments, the light sensor and the LED assembly are integrated into a single chip. Moreover, the chip and the control circuitry may be integrated into a single discrete package.

In certain embodiments, an LED of the LED assembly serves to measure the ambient light during the momentary interruption of the operation of the LED assembly as a light source. Further, in some embodiments, the LED assembly may include a plurality of LEDs, at least one (or even each) LED being operable alternatively as a light source or a light sensor. The control circuitry may then operate (during collective operation of the LED assembly as a light source) each of the LEDs of the LED assembly as a light sensor while operating the other LEDs as light sources, thereby facilitating measurement, by the LED operated as a light sensor, of a light level produced by the other LEDs. The control circuitry may also operate a first set of one or more of the LEDs of the LED assembly as a light sensor while operating a second set of one or more of the LEDs not in the first set as light sources, thereby facilitating measurement, by the first set, of the light level produced by the second set.

One or more of the LEDs in the LED assembly may include a lens for dispersing light emitted by the LED(s), i.e., one or more of the LEDs may each have an individual lens, or a lens may be shared by one or more LEDs. The lens may have an optical coating that reduces dirt accumulation, thereby improving reliability of the ambient light detection. The system may include a temperature sensor near the LED(s) used to measure the ambient light level, and the control circuitry may measure the ambient light based on the voltage at the LED(s) and the temperature measured by the temperature sensor.

In a further aspect, embodiments of the invention feature a method for controlling operation of an LED assembly including or consisting essentially of one or more LEDs. The LED assembly is operated as a light source, and operation of the LED assembly is repeatedly temporarily interrupted. During each of the temporary interruptions, the ambient light level is measured, and the light intensity of the LED assembly is iteratively adjusted based on the measured ambient light levels. Iteratively adjusting the light intensity may include or consist essentially of gradually decreasing the light intensity as the ambient light levels increase and/or gradually increasing the light intensity as the ambient light levels decrease.

In yet another aspect, embodiments of the invention feature a method for testing an LED assembly during operation thereof as a light source. (The LED assembly includes or consists essentially of a plurality of LEDs, at least some of which are operable alternatively as a light source or a light sensor.) At least one LED is temporarily operated as a light sensor while at least one of the other LEDs is simultaneously operated as a light source, and this is repeated until a plurality of the LEDs have each been operated as a light sensor. An operational parameter of the LED assembly is inferred from signals provided by the LEDs operated as light sensors.

Embodiments of the invention may include one or more of the following, in any of a variety of combinations. All of the LEDs not being operated as light sensors may be collectively operated as the light source. The operation of at least one LED as a light sensor may be repeated until each of the LEDs has been operated as a light sensor. The operational parameter may indicate whether an LED operated as a light sensor is defective. The operational parameter may include or consist essentially of the brightness of the LEDs collectively operated as a light source. The degree of uniformity of the brightness distribution of the LED assembly may be inferred from the successively measured brightnesses. The operational parameter may indicated whether a first LED operated as a light source is defective, and only the first LED may be operated as a light sources while at least one (or even all) of the remaining LEDs is operated as a light sensor. The temporary operation of the LED(s) as a light sensor may not be detectable by eye (i.e., the human eye), and/or the duration of the temporary operation may not exceed 5 ms, or even 1 ms.

In a further aspect, embodiments of the invention feature an LED system including or consisting essentially of a plurality of LEDs and control circuitry. At least some of the LEDs are operable alternatively as a light source or a light sensor. The control circuitry successively operates sets of one or more of the LEDs as light sensors while simultaneously operating at least one of the other LEDs as a light source, and also determines an operational parameter of the LED system from the successive signals measured by the LEDs operated as light sensors.

In another aspect, embodiments of the invention feature a method for communication via an LED assembly that includes or consists essentially of one or more LEDs. The LED assembly is operated as a light source, and the operation of at least one LED is temporarily interrupted. During the temporary interruption, a free-space optical communication is received, and at least one action is taken based on the communication.

Embodiments of the invention may feature one or more of the following in any of a variety of combinations. The action may include or consist essentially of controlling the LED assembly based on the received optical communication and/or transmitting information within the communication to at least one node in a network to which the LED assembly is connected. The at least one LED may receive the optical communication. The LED assembly may include or consist essentially of a plurality of LEDs, and the operation of each of the LEDs may be interrupted during receipt of the optical communication. The operation of at least one LED may be temporarily interrupted, and during the temporary interruption, an optical communication may be transmitted.

In yet another aspect, embodiments of the invention feature a lighting system including or consisting essentially of an LED assembly operable as a light source and control circuitry. The LED assembly includes or consists essentially of one or more LEDs. The control circuitry momentarily interrupts operation of at least one of the LEDs as a light source to enable receipt of, during the temporary interruption, a free-space optical communication, and takes at least one action based on the communication. The control circuitry may adjust operation of the LED assembly as a light source based on the received optical communication and/or transmit information within the communication to at least one node in a network to which the LED assembly is connected.

### BRIEF DESCRIPTION OF THE DRAWINGS

The foregoing will be more readily understood from the following description of the invention in conjunction with the drawings, in which:

FIG. 1A is a schematic diagram illustrating a lighting system including an LED assembly and light sensor in accordance with one embodiment;

FIG. 1B is a schematic diagram illustrating a lighting system including an LED assembly operable as a light source or light sensor in accordance with one embodiment;

FIG. 1C is a plan view of the “front,” i.e., light-emitting, surface of a lighting system including multiple LEDs operable as light sources or light sensors in accordance with one embodiment;

FIG. 2A is a time plot of the ambient light during a night/day cycle;

FIG. 2B is a time plot of the on/off status of an LED assembly during the cycle shown in FIG. 2A in accordance with one embodiment;

FIG. 2C is a time plot of the on/off status of a light sensor during the cycle shown in FIG. 2A in accordance with one embodiment; and

FIG. 3 is a flow chart illustrating a method of operating an LED assembly based on the ambient light level in accordance with various embodiments.

### DESCRIPTION

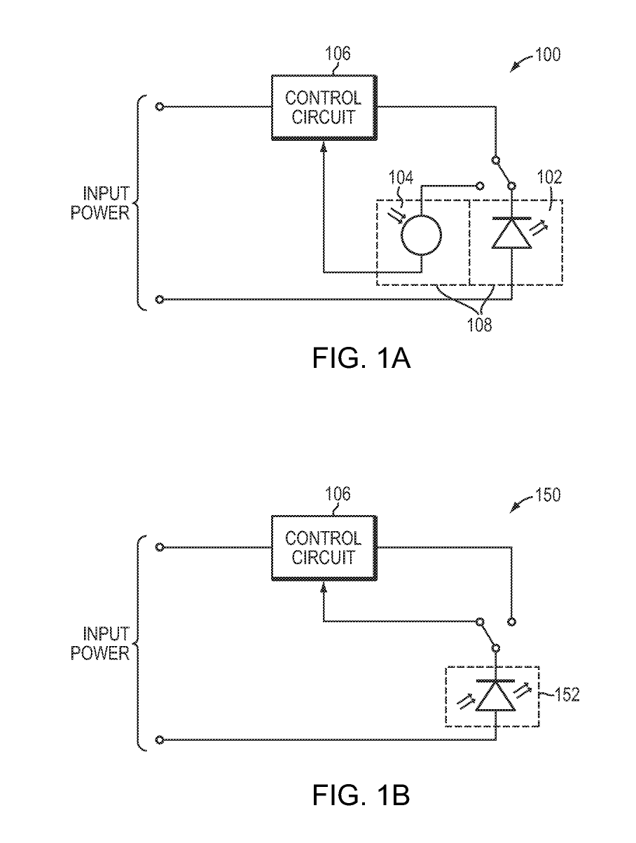

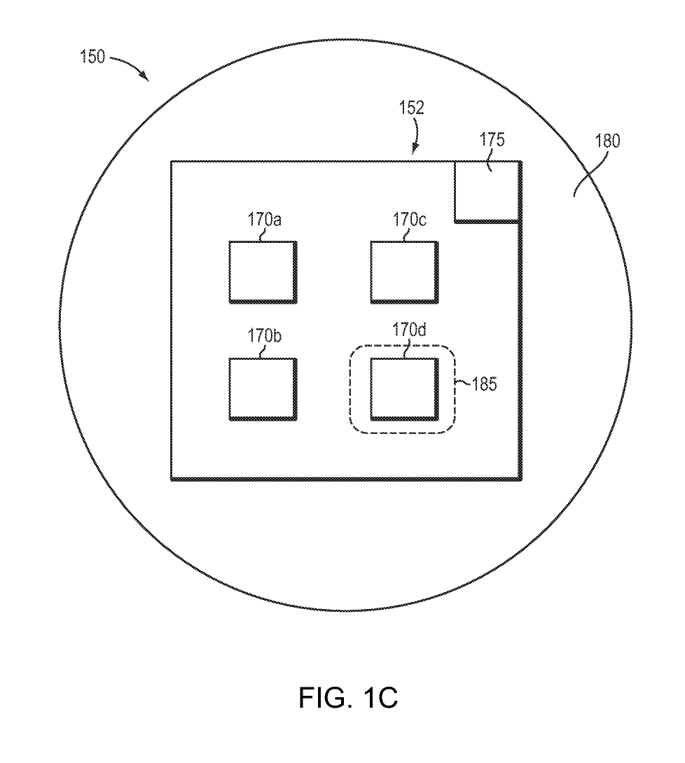

FIG. 1A schematically illustrates an exemplary lighting system 100 in accordance with various embodiments of the present invention. The system 100 includes an LED assembly 102, a light sensor 104, and control circuitry 106. The LED assembly 102 includes at least one LED. In FIG. 1A, a single LED is shown; however, in general, the LED assembly 102 may include multiple LEDs, which may, for example, form an array of LEDs collectively operating as a single light source. The light sensor 104 may be any component capable of detecting the presence or absence of light and providing an electronic signal indicative thereof. Preferably, the light sensor 104 provides an electronic (analog or digital) signal whose magnitude quantifies the detected light level. For example, the sensor 104 may convert detected light into a voltage or current signal proportional to the light intensity at a particular frequency or within a particular spectral range (typically within the visible portion of the electromagnetic spectrum). Examples of suitable sensors 104 include photodiodes, phototransistors, photoresistors, radiometers, photometers, colorimeters, spectral radiometers, cameras, or any combination of two or more such devices. In some embodiments, the signal measured by the light sensor 104 depends on the temperature of the sensor 104. The lighting system 100 may, therefore, include a temperature sensor (shown, e.g., in FIG. 1C), preferably located in the vicinity of the light sensor 104, which facilitates determining the light level more accurately based on simultaneously acquired signals from the light sensor and the temperature sensor, and the functional dependence of the light sensor signal strength on the temperature (which functional relationship may be ascertained, for example, via calibration).

The control circuit 106 generally serves to control operation of the LED assembly 102 based on a light level measured by the light sensor 104. More specifically, in one embodiment, the control circuit 106 includes a driver component (e.g., a conventional LED ballast) that turns the LED assembly on or off as needed. The driver component may also be capable of adjusting the brightness of the LED assembly (e.g., by adjusting the drive voltage and/or adjusting the timing of the on/off cycle, as described in more detail below). Further, the control circuit 106 may include a processing component that converts the electronic signal received from the light sensor 104 into a control signal utilized by the driver component and related circuitry, which jointly implement functionality for temporarily interrupting the operation of the LED assembly 102 as a light source and reading out the sensor 104 while the LED assembly 102 is turned off. In FIG. 1A, this functionality is conceptually illustrated with a switch that selectively connects the control circuit 106 to the LED assembly 102 or the light sensor 104. However, alternatively to (electronically operated) mechanical switches, purely electronic components (e.g., transistors) may also be used to temporarily turn off the LED assembly and simultaneously measure the ambient light level.

More generally, the processing component may be based on a conventional microprocessor or microcontroller executing programming instructions. Any suitable programming language may be used to implement without undue experimentation the sensing, timing, and switching and functions described in detail below.

In contrast to conventional ambient-light-controlled lamps, in which the ambient light sensor is generally separated from and/or shielded from the light source, embodiments of the present invention allow locating the light sensor 104 in physical and optical proximity to the LED assembly 102. Because the control circuit 106 synchronizes ambient light measurements with interruptions of the LED operation (i.e., times when the LED assembly 102 is turned off), no shielding between the two devices is needed. As a result, the LED assembly 102 and light sensor 104 may be integrated into a single, compact unit, e.g., a single chip, which, in turn, reduces manufacturing and/or installation cost. Further, the LED assembly 102, light sensor 104, and control circuit 106 may be packaged so as to form a single, discrete unit. In one embodiment, the control circuit 106 is implemented on a printed circuit board (e.g., in a ceramic substrate) to which the light sensor 104 and one or more LED dice (or a single chip containing both) are subsequently soldered. The sensor 104, LED(s), and other electronic components may, optionally, be encapsulated in a polymer or other protective material. Manufacturing and packaging methods for electronic devices including LEDs are generally known to persons of ordinary skill in the art, and can be applied to the production of lighting systems in accordance with various embodiments of the invention without undue experimentation.

FIG. 1B illustrates an alternative lighting system 150, in which the LED assembly 152 (or one or more LEDs of the assembly) also serves as the light sensor. In this embodiment, the control circuit 106 operates the LED assembly 152 alternately as a light source or light sensor: when the LED assembly 152 is not connected to the input power supply (i.e., is turned off), incident light may cause a voltage drop across the LED assembly 152 that can be read out by the control circuit 106. If the assembly 152 includes multiple LEDs, an individual one of them may be used as the sensor; however, using several or all of the LEDs collectively as a sensor may improve the accuracy of the reading due to an overall larger signal. Employing the LED assembly 152 itself to measure the ambient light level may further reduce the complexity and, hence, cost of the overall lighting system.

One or more of the LEDs of lighting system 150 may also be utilized to sense one or more operational parameters of LED assembly 152 during operation thereof. As depicted in FIG. 1C, the LED assembly 152 may include multiple LEDs 170, and each LED 170 may be in optical proximity (e.g., have a direct line of sight) to the others. Due to the optical proximity of LEDs 170 in preferred embodiments, generally no mechanisms such as mirrors or light-pipes are necessary to direct light from one or more light-emitting LEDs 170 to an LED 170 being utilized to detect the light. (Although FIG. 1C depicts LED assembly 152 as featuring four LEDs 170, LED assemblies in accordance with embodiments of the invention may feature more or fewer LEDs.) Each of the LEDs 170 in LED assembly 152 may emit light of a different color from the other LEDs 170, or one or more of the LEDs 170 may emit light of the same color. LED assembly 152 may also feature a temperature sensor 175 to facilitate the above-described temperature-dependent sensing techniques. As shown in FIG. 1C, the lighting system 150 may advantageously feature a lens 180 for dispersing light emitted by the LEDs 170. The lens 180 may encapsulate the LEDs 170 and provide protection from the outside environment. Lens 180 may include or comprise, e.g., glass or a plastic material such as PMMA or silicone. In preferred embodiments, the lens 180 features an optical coating that reduces dirt accumulation, thereby improving reliability of the ambient light detection described above. In addition to or instead of lens 180, lighting system 150 may include one or more lenses 185 each covering an individual LED 170. Lens 185 may have the same properties as lens 180, and may even cover multiple LEDs 170.

One or more (and even each) of the LEDs 170 may be turned off in turn, e.g., in round-robin fashion, and utilized to sense characteristics of the other LEDs 170 and/or the light emitted therefrom. For example, an LED 170a may be utilized to sense the brightness, color, and/or other characteristics of the light collectively emitted by the remaining LEDs 170b, 170c, 170d. Repeating such sensing with one or more of the remaining LEDs 170 provides sufficient information to infer one or more operational parameters of LED assembly 152, including, for example, the brightness and/or color coordinates of LED assembly 152 when all LEDs 170 are collectively operated as light sources, as well as characteristics of the light emitted by a particular one of the LEDs when this deviates substantially from the light emitted by the other LEDs. Furthermore, since each LED 170 is positioned in a specific location within LED assembly 152, the above-described “round-robin” sensing may also enable the inference of the degree of brightness uniformity of the light emitted by LED assembly 152. In various embodiments, the periods of interruption of the LED(s) utilized as sensors are short enough to be undiscernible by a human observer (e.g., shorter than about 5 ms, preferably shorter than about 1 ms). Consequently, to a human, the LED assembly 152 appears to continuously provide lighting at a substantially constant intensity and at substantially constant color coordinates.

The utilization of one or more of the LEDs 170 as light sensors may also indicate whether one or more of the LEDs 170 is defective, e.g., emitting light of a different brightness or of different color coordinates than its nominal baseline value (e.g., as a function of the voltage applied thereto by the control circuit). The operational information of a particular LED 170 may be gleaned from the data provided when it is operated as a sensor, e.g., light characteristics sensed by the LED 170 that are considerably different from those detected by other LEDs 170 or outside of a normal operating range of LED assembly 152 may indicate that this LED 170 is defective. Moreover, if an LED 170 is defective and emitting light of a different brightness and/or color coordinates than its nominal value, the light detected by one or more (or even all) of the other LEDs 170 when they are operated as sensors will include the characteristics of light produced by the defective LED 170; furthermore, the light detected by the defective LED 170 operated as a sensor will not include such characteristics (i.e., the light detected by the defective LED 170 may be within normal operating tolerances of LED assembly 152). Thus, the defective LED 170 may be identified by the sensing of the “defective” light therefrom by the other LEDs 170 (operated, for example, in round-robin fashion as sensors), and/or sensing of “normal” light by the defective LED 170 operated as a sensor. In other words, if one of the LEDs is producing abnormal light, the detected light from LED assembly 150 may appear normal only when the defective LED is off and acting as a sensor; when the other LEDs act as sensors in their turn, the contribution of the defective LED will cause the overall light to deviate from expectations.

In another embodiment, if the above-described round-robin sensing scheme is utilized, and one or more LEDs 170 are suspected of being defective, additional diagnostic sensing modes may be utilized to verify the defectiveness and/or supply additional data. For example, the one or more suspected defective LEDs 170 may be operated as light emitters while the remaining LEDs 170 are utilized as sensors. Since only light from the defective LEDs 170 is thereby sensed by the sensing LEDs 170, this method may be utilized to verify the defective status of the LED(s) 170 and/or provide specific information about, e.g., the light spectrum emitted by the LED(s) 170.

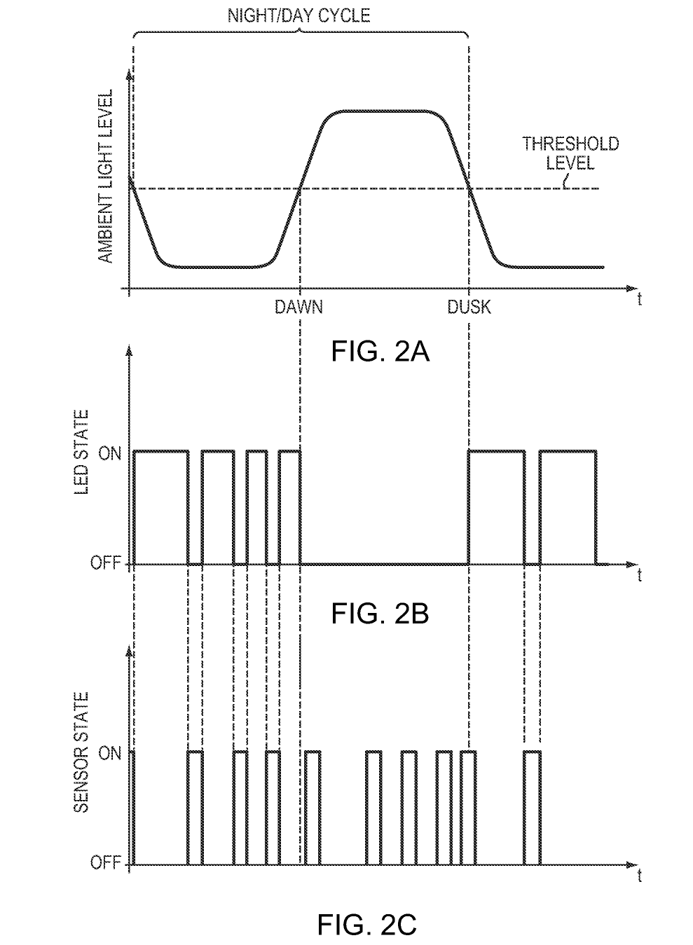

The basic function of lighting systems in accordance with various embodiments (e.g., systems 100 or 150) is illustrated in FIGS. 2A-2C with time plots of the ambient light level and corresponding operational states of the LED assembly and light sensor. FIG. 2A shows the ambient light level during a typical night/day cycle. A threshold light level (which may be used to define dawn and dusk) is indicated by the dashed line. As illustrated in FIG. 2B, the LED assembly is generally turned on when the ambient light level is below this pre-determined threshold (i.e., during the night), and turned off when the ambient light level is above the threshold (i.e., during the day). However, during the night, the LED assembly is repeatedly turned off for brief periods of time, during which measurements of the ambient light are taken by the light sensor (which corresponds to the “on” state of the sensor), as shown in FIG. 2C. In various embodiments, these periods of interruption are short enough to be undiscernible by a human observer (e.g., shorter than about 5 ms, preferably shorter than about 1 ms). Consequently, to a human, the LED assembly appears to continuously provide lighting during the night. (Note that the relative time periods in FIGS. 2A-2C are not drawn to scale, but instead are intended to illustrate the principles. For example, in typical embodiments, the ambient light level will be measured tens of times during both night and day, not just a few times.)

Light measurements may be taken periodically, i.e., at constant intervals. Alternatively, as illustrated in FIGS. 2A-2C, the frequency of the ambient light measurements may increase toward dawn to ensure that the assembly is turned off as soon as, or not long after, the ambient light level has exceeded the threshold. Similarly, as shown in FIG. 2C, the frequency of the measurements may increase toward dusk, such that the LED assembly is turned on in time. For example, while the time between successive measurements around noon or midnight may be about thirty minutes, this period may be shortened to five minutes or less as dusk or dawn approaches. In some embodiments, two ambient light thresholds may be used: when the lower threshold is exceeded, the LED assembly is turned off, and when the ambient light level falls below the higher threshold, the LEDs are turned back on. This way, sufficient lighting is provided at all times. Further, in some embodiments, measurements of the ambient light may be taken continuously during the day, rather than at intervals. For example, if the LED (or LED assembly) itself is used as the light sensor when not providing illumination, the measurement may essentially consist of providing any voltage that is created across the LED by incident ambient light as an input signal to the control circuitry.

In some embodiments, the lighting system does not rely upon a single ambient-light threshold beyond which the LED assembly is switched fully on or off. Instead, the ambient light level is measured as described above, and the emitted light intensity of the LED assembly is adjusted iteratively based thereon. For example, the light intensity of the LED assembly may be gradually decreased as the ambient light levels increase (or vice versa), providing an entire range of emitted-light intensity depending upon ambient conditions. Of course, such embodiments may also incorporate one or more ambient-light thresholds, beyond which the LED assembly is “fully on,” i.e., emitting at it's highest intensity, or turned off.

While FIGS. 2A-2C conceptually illustrate the operating principle of the instant invention at the example of a night/day cycle, the same principles may be applied in other contexts. For example, instead of sunlight, the ambient light may be light provided by artificial light sources (e.g., in the basement of a building, in an airplane at night, etc.), and the LED assembly may provide security lighting in case the regular light source fails.

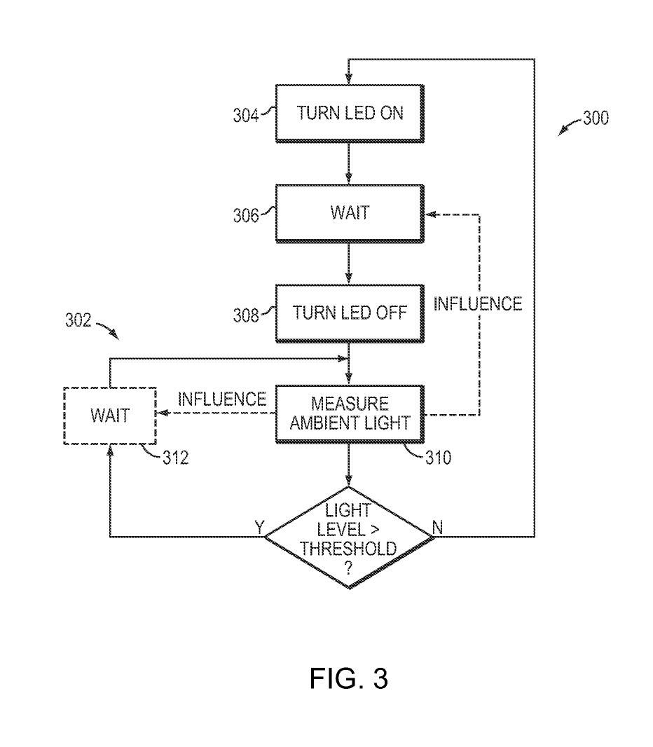

FIG. 3 summarizes various methods of operating an LED lamp with an integrated light sensor (which may be one of the LEDs) in form of a flowchart. The method includes two interlinked cycles (or “loops”) 300, 302, which may be performed repetitively. The first loop 300 corresponds to low ambient light levels, and involves turning the LED assembly on (step 304), waiting for a period of time (step 306), and then turning the LED off (308) to measure the ambient light level (step 310). Unless the light level exceeds a specified threshold, this cycle is repeated. Once the light level exceeds the threshold, however, the second loop 302 is traversed, i.e., the light level is measured repeatedly until it falls below (or just hits) the threshold. During this second cycle 302, the LED remains turned off. Successive measurements may, but need not be separated by waiting periods (step 312). Further, as illustrated by dashed lines, the measured light level may influence the wait periods (steps 306 and/or 312).

Lighting systems in accordance with various embodiments (e.g., systems 100 or 150) may also advantageously to enable free-space optical communication (as opposed to, e.g., optical communication via optical fiber) between the lighting system and, e.g., adjoining lighting systems and/or other nearby lighting sources. As described above, the light emission of one or more of the LEDs 170 in the LED assembly may be temporarily interrupted, and the LED(s) instead utilized as optical sensors. (In addition, one or more of the LEDs may be utilized as sensors during night or other times when the LED assembly is not emitting light; such utilization may still be “temporary,” i.e., performed periodically on short timescales.) The sensing LED(s) may be utilized to receive modulated optical communications from another optical source, e.g., a nearby LED or LED-based lamp. The communications may include, e.g., instructions to alter the emitted-light intensity, color coordinates, etc. of the LED assembly, or other data. In some embodiments, rather than utilizing one of the LEDs as the sensor, the lighting system incorporates a separate light sensor (like those described above) integrated therewithin; preferably the sensor receives the optical communication while the light emission of one or more of the LEDs in the lighting system is temporarily interrupted.

Receipt of the optical communications by the sensing LED may be facilitated by temporarily interrupting the light emission of at least one (or even all) of the other LEDs in the LED assembly during the time period the sensing LED is receiving the communication. Even in an embodiment when all of the LEDs of the assembly are briefly turned off, the interruption of light emission from the LED assembly is preferably short enough to be indiscernible to a human observer. In some embodiments, multiple LEDs are utilized as sensors to receive optical communications, e.g., in order to provide redundancy.

In some embodiments of the invention, the lighting system has bi-directional communication capability, i.e., one or more of the LEDs may be utilized to transmit modulated optical communications during temporary interruptions of their “normal” light emission. The above-described control circuits preferably include modulation/demodulation circuitry, and may even include circuitry such as a microprocessor, microcontroller, or the like to process the transmitted and/or received communications. For example, the circuitry may monitor the readings obtained by an LED when used as a sensor in order to detect a trigger sequence of light pulses that “wakes up” a communication module and causes it to treat subsequent pulses as data, which are stored in local memory and interpreted by the processor. The signals may, for example, represent commands that adjust the operation of the lighting system. If the lighting system is connected in a network configuration with other LED-based lighting systems or with one or more computers configured as network nodes, the received message may be passed to other system entities—e.g., broadcast to the network or passed to a node whose identity is specified in the message. Suitable network and communication circuitry are well characterized in the art and a networked system of intercommunicating LED-based lighting systems can be straightforwardly configured without undue experimentation.

The systems and methods described above may by modified or augmented in several ways. For example, in certain embodiments, light is not only measured when the LED assembly is turned off, but also during operation of the LED(s) as a light source, as previously described. Thus, the operation of the LED assembly may be monitored, and any failure of the assembly to properly function may be readily and automatically detected. In addition, based on measurements of the light level generated by the LED(s), their operation may be adjusted to achieve a desired light level or brightness. For example, as the LED(s) age and decrease in efficiency, the input power may be increased to maintain the original light level. The LED lighting system may also be operated in conjunction with a dimmer that sets a desired brightness, which may be achieved, for example, by adjusting the durations of the temporary interruption of the LED operation. To generate dim light, the interruption periods may be lengthened beyond those necessary to take a measurement, as long as they remain short enough to avoid noticeable flickering.

Measurements of the light level produced by the LED assembly may be taken by a dedicated light sensor. Alternatively, in embodiments in which the LED assembly includes two or more LEDs, one of them may be turned off and used as a light sensor. In some embodiments, the LEDs of an assembly are successively operated as sensors in a round-robin fashion such that, at any time, one of the LEDs measures the light collectively produced by the others.

Although the present invention has been described with reference to specific details, it is not intended that such details are regarded as limitations upon the scope of the invention, except as and to the extent that they are included in the accompanying claims.

What is claimed is:

1. A method for controlling operation of a light-emitting-diode (LED) assembly comprising at least one LED, the method comprising:
(a) operating the LED assembly as a light source;
(b) temporarily interrupting operation of the LED assembly and, during the temporary interruption, measuring an ambient light level; and
(c) adjusting a light intensity of the LED assembly based on the measured ambient light level.

2. The method of claim 1, wherein adjusting the light intensity of the LED assembly comprises decreasing the light intensity when the ambient light level exceeds a threshold.

3. The method of claim 2, wherein decreasing a light intensity of the LED assembly comprises discontinuing operation of the LED assembly as a light source.

4. The method of claim 3, wherein step (b) is repeated at time intervals that decrease toward dawn.

5. The method of claim 3, wherein step (b) is repeated at time intervals that decrease as the ambient light level increases toward the threshold.

6. The method of claim 3, further comprising:
(d) measuring the ambient light level while the LED assembly is not operated as a light source; and
(e) when the ambient light level falls below the threshold, resuming operation of the LED assembly as a light source.

7. The method of claim 6, further comprising repeating steps (a) through (e).

8. The method of claim 6, wherein step (d) is repeated at time intervals that decrease toward dusk.

9. The method of claim 6, wherein step (d) is repeated at time intervals that decrease as the ambient light level decreases toward the threshold.

10. The method of claim 1, wherein measuring the ambient light level comprises using an LED of the LED assembly as a light sensor.

11. The method of claim 10, wherein measuring the ambient light level further comprises measuring a temperature, and determining the ambient light level based on a voltage at the LED used as the light sensor and the measured temperature.

12. The method of claim 1, wherein measuring the ambient light level comprises using a light sensor optically proximate the LED assembly.

13. The method of claim 1, wherein the temporary interruption is not detectable by eye.

14. The method of claim 1, wherein a duration of the temporary interruption does not exceed 5 ms.

15. The method of claim 1, wherein step (b) is repeated periodically.

16. The method of claim 1, wherein step (b) is repeated at specified time intervals in the range from about 1 second to about 30 minutes.

17. The method of claim 1, further comprising measuring a light level during the operation of the LED assembly as a light source.

18. The method of claim 17, further comprising adjusting the operation of the LED assembly based on the measured light level.

19. The method of claim 18, wherein adjusting the operation of the LED assembly comprises adjusting a duration of the temporary interruption and periodically repeating the temporary interruption, thereby adjusting an effective brightness of the LED assembly.

20. The method of claim 18, wherein adjusting the operation of the LED assembly comprises periodically repeating the temporary interruption and adjusting a brightness of the LED assembly by adjusting a drive current of the LED assembly based at least in part on the ambient light levels measured during the temporary interruptions.

21. The method of claim 17, wherein the LED assembly comprises a plurality of LEDs and wherein measuring the light level comprises temporarily operating one of the LEDs as a light sensor.

22. The method of claim 21, wherein each of the LEDs is operated as a light sensor individually and sequentially in a round-robin fashion.

23. A lighting system comprising:
an LED assembly operable as a light source, the LED assembly comprising at least one LED;
control circuitry for (i) momentarily interrupting operation of the LED assembly as a light source and measuring, during the temporary interruption, an ambient light, and (ii) adjusting operation of the LED assembly as a light source based on the measured ambient light level.

24. The system of claim 23, wherein the control circuitry discontinues the operation of the LED assembly as a light source when the measured ambient light level exceeds a threshold.

25. The system of claim 23, further comprising a light sensor for measuring the ambient light, the sensor being located in optical proximity to the LED assembly.

26. The system of claim 25, wherein the light sensor and the LED assembly are integrated into a single chip.

27. The system of claim 26, wherein the chip and the control circuitry are integrated into a single discrete package.

28. The system of claim 25, wherein the light sensor comprises at least one of a photodiode, a phototransistor, a photoresistor, a radiometer, a photometer, a colorimeter, a spectral radiometer, or a camera.

29. The system of claim 23, wherein an LED of the LED assembly serves to measure the ambient light during the momentary interruption of the operation of the LED assembly as a light source.

30. The system of claim 29, wherein the LED assembly comprises a plurality of LEDs, at least one LED being operable alternatively as a light source or a light sensor.

31. The system of claim 30, wherein during operation of the LED assembly as a light source, the control circuitry operates a first set of one or more of the LEDs of the LED assembly as a light sensor while operating a second set of one or more of the LEDs not in the first set as light sources, thereby facilitating measurement, by the first set, of a light level produced by the second set.

32. The system of claim 29, wherein the LED assembly comprises a plurality of LEDs, each LED being operable alternatively as a light source or as a light sensor.

33. The system of claim 32, wherein during operation of the LED assembly as a light source, the control circuitry operates each of the LEDs of the LED assembly as a light sensor while operating the other LEDs as light sources, thereby facilitating measurement, by the LED operated as a light sensor, of a light level produced by the other LEDs.

34. The system of claim 29, wherein the LED assembly further comprises a lens for dispersing light emitted by the at least one LED.

35. The system of claim 34, wherein the lens comprises an optical coating that reduces dirt accumulation, thereby improving reliability of the ambient light detection.

36. The system of claim 29, further comprising a temperature sensor proximate the LED used to measure the ambient light level, wherein the control circuitry measures the ambient light based on a voltage at said LED and a temperature measured by the temperature sensor.

37. A method for controlling operation of a light-emitting-diode (LED) assembly comprising at least one LED, the method comprising:
(a) operating the LED assembly as a light source;
(b) repeatedly temporarily interrupting operation of the LED assembly and, during each of the temporary interruptions, measuring an ambient light level; and
(c) iteratively adjusting a light intensity of the LED assembly based on the measured ambient light levels.

38. The method of claim 37, wherein iteratively adjusting the light intensity of the LED assembly comprises gradually decreasing the light intensity as the ambient light levels increase.

39. The method of claim 37, wherein iteratively adjusting the light intensity of the LED assembly comprises gradually increasing the light intensity as the ambient light levels decrease.
